(19) United States
(12) Patent Application Publication
(10) Pub. No.: US 2017/0302974 A1
(43) Pub. Date: Oct. 19, 2017

(54) SYSTEMS AND METHODS FOR ENHANCED VIDEO SERVICE

(71) Applicant: ENSTIGO, INC., Pasadena, CA (US)

(72) Inventors: Matthew D. Papish, Encino, CA (US); Francisco Ramos, Santa Monica, CA (US)

(21) Appl. No.: 15/448,093

(22) Filed: Mar. 2, 2017

Related U.S. Application Data
(63) Continuation of application No. 14/866,689, filed on Sep. 25, 2015, now abandoned.
Application No. 14/866,689 is a continuation of application No. 13/794,469, filed on Mar. 11, 2013, now abandoned.

(51) Int. Cl. H04N 21/234; H04N 21/81; H04N 21/643; H04N 21/472; H04N 21/274; H04N 21/2668; H04N 21/258; H04N 21/854; H04N 21/2343

(52) U.S. Cl. CPC H04N 21/23424; H04N 21/854; H04N 21/812; H04N 21/64322; H04N 21/2343; H04N 21/274; H04N 21/2668; H04N 21/25891; H04N 21/47205

(57) ABSTRACT

The field of the invention relates to systems and methods for operation of a video enhancement service, and more particularly to systems and methods that provide a web-based video enhancement platform. In an embodiment, the system includes a video enhancement operating system and a webserver coupled to a public network and accessible to one or more users. The video enhancement platform includes a database that stores user profile data associated with the one or more users. The platform is configured to receive source information of a video, retrieve the video, convert the video to a predetermined format, receive one or more requests to make one or more enhancements to the video, enhance the video according to the one or more requests, and combine the video into a self-contained file comprising a rendering engine and the enhancement for saving and sharing.

### CROSS-REFERENCE TO RELATED APPLICATIONS

The present application is a continuation application of U.S. patent application Ser. No. 14/866,689, filed Sep. 25, 2015, which is a continuation application of U.S. patent application Ser. No. 13/794,469, filed Mar. 17, 2013, now abandoned, which are hereby incorporated by reference in their entireties.

### FIELD OF THE INVENTION

The field of the invention relates to systems and methods for enhancing videos, and more particularly to systems and methods that provides a web-based service for enhancing videos.

### BACKGROUND OF THE INVENTION

Video is taking over the web (via the use of desktop, smartphone and tablet) as the premium format for online advertising, and top traffic, data and transaction driver. According to a recent Forrester Research report, videos are fifty-three percent more likely than text to appear on the first page of search results. One of the reasons is because video is a proven search engine optimization (SEO) amplifier due to the fact that search engines often give higher ranks to web sites with videos. Another study has shown that e mail click-through rates increased by fifty percent when video was included.

One reason for the growth of videos on the web may be because many viewers have short attention spans. It has been shown that the use of video increases viewing time as much as tenfold. Another reason may be because people love watching, remixing and sharing online video. In response to the growing popularity of video consumption, video content marketing, video advertising and video based e-commerce have been exploding.

Marketers have learned that in-player call-to-action features significantly improve conversion rates. It is the common belief that all video, media and advertising spend in the future will be measured, optimized and packaged on a granular data basis. However, most online video players are disconnected from the data and content all around it. The only thing that has changed about online video in the past decade is the size of the box and the quality of the picture. Most video players also require installation of proprietary players and adoption of “overlay” architecture. A new system allowing marketers and consumers to interact with video on the web is needed.

Accordingly, improved systems and methods to provide video enhancing tools and services on the web capable of reaching audiences across all surface areas (web, smartphone and tablet) may be desirable.

### SUMMARY OF THE INVENTION

The field of the invention relates to systems and methods for enhancing videos, and more particularly to systems and methods that provide a web-based platform for enhancing videos.

The web-based platform for enhancing videos (herein may be referred to as the platform) is engineered to capture customer and social network data from one single-point of contact. The platform may operate as a web site and does not require the registration, download and/or installation of software. Alternatively, software may be downloaded and/or installed. The platform works on all major operating systems, mobile operating systems, browsers and devices, and enables users to grab video from the most popular video sharing sites. The platform may also enhance text, image, audio, and other media.

The web-based platform for enhancing videos provides a simple drag-and-drop mechanism that allows business users and consumers the ability to remix video with applications pulled directly from the web. For example, data from applications such as Twitter, Facebook, Flickr, LinkedIn, Google+, Wikipedia, maps, and the like, may be mixed with videos from Vimeo, YouTube, SoundCloud, and the like. The resulting enhanced videos may then be posted back on the web.

In an embodiment, the platform includes a video enhancement operating system and a webserver coupled to a public network and accessible to one or more users. The video enhancement platform includes a database that stores user profile data associated with the one or more users. The platform is configured to receive source information of a video, retrieve the video, convert the video to a predetermined format, receive one or more requests to make one or more enhancements to the video, enhance the video according to the one or more requests, and combine the video into a self-contained file comprising a rendering engine and the enhancements for saving and sharing.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

In order to better appreciate how the above-recited and other advantages and objects of the inventions are obtained, a more particular description of the embodiments briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1 is an exemplary diagram of a web-based platform for enhancing videos according to an embodiment of the present invention.

FIG. 2 is another exemplary diagram of a web-based platform for enhancing videos according to an embodiment of the present invention.

FIG. 2a is an exemplary diagram of a data file according to an embodiment of the present invention.

FIG. 3 is an exemplary user interface according to an embodiment of the present invention.

FIG. 4 is another exemplary user interface according to an embodiment of the present invention.

FIG. 5 is another exemplary user interface according to an embodiment of the present invention.

FIG. 6 is another exemplary user interface according to an embodiment of the present invention.

FIG. 7 is another exemplary user interface according to an embodiment of the present invention.

FIG. 8 is another exemplary user interface according to an embodiment of the present invention.

FIG. 9 is another exemplary user interface according to an embodiment of the present invention.

FIG. 10 is another exemplary user interface according to an embodiment of the present invention.

FIG. 11 is another exemplary user interface according to an embodiment of the present invention.

FIG. 12 is another exemplary user interface according to an embodiment of the present invention.

FIG. 13 is another exemplary user interface according to an embodiment of the present invention.

FIG. 14 is another exemplary user interface according to an embodiment of the present invention.

FIG. 15 is another exemplary user interface according to an embodiment of the present invention.

FIG. 16 is another exemplary user interface according to an embodiment of the present invention.

FIG. 17 is another exemplary user interface according to an embodiment of the present invention.

FIG. 18 is another exemplary user interface according to an embodiment of the present invention.

FIG. 19 is another exemplary user interface according to an embodiment of the present invention.

FIG. 20 is another exemplary user interface according to an embodiment of the present invention.

FIG. 20a is an exemplary webpage according to an embodiment of the present invention.

FIG. 21 is another exemplary user interface according to an embodiment of the present invention.

FIG. 22 is an exemplary process according to an embodiment of the present invention.

FIG. 23 is another exemplary process according to an embodiment of the present invention.

### DETAILED DESCRIPTION OF THE PREFERRED EMBODIMENTS

### Preferred Systems

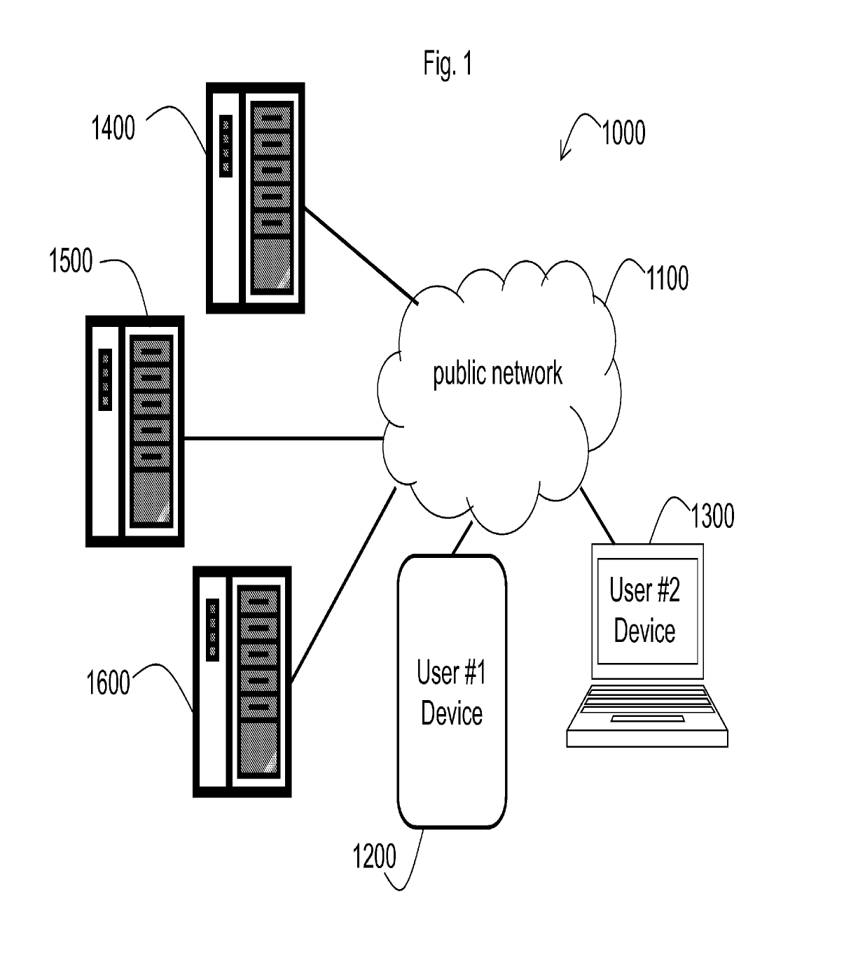

FIG. 1, according to an embodiment, shows a web-based video enhancement system 1000. The system 1000 generally includes a web-based platform for enhancing videos 1400 which may be distributed on one or more physical servers, each having processor, memory, a computer operating system, and input/output interface, and a network interface all known in the art. System 1000 may further include a plurality of video linked sources or servers 1500, a plurality of video or advertising servers 1600, and a plurality of end user computing devices 1200/1300 coupled to a public network 1100, such as the Internet and/or a wireless network.

Generally, the platform 1400 is configured to receive source information of a video (e.g., from a user), retrieve the video from one or more video linked sources or servers 1500, convert the video to a predetermined format, receive one or more requests from the user to make one or more enhancements to the video, enhance the video according to the one or more requests, and combine the video into a self-contained file comprising a rendering engine and the enhancements for saving and sharing at one or more video or advertising servers 1600. The plurality of video linked sources or servers 1500 include, e.g., YouTube, Vimeo, SoundCloud, Facebook, Wikipedia, and so on. The plurality of video or advertising servers 1600 include the web-based platform for enhancing videos 1400, public Internet sites (e.g., Google Doubleclick, and so on), and private sites (e.g., an individual web site, a corporation web site, and so on). It is noted that video or ad servers 1600 may be the same servers 1500. The web-based platform for enhancing videos 1400 may also reside in a cloud-computing based service.

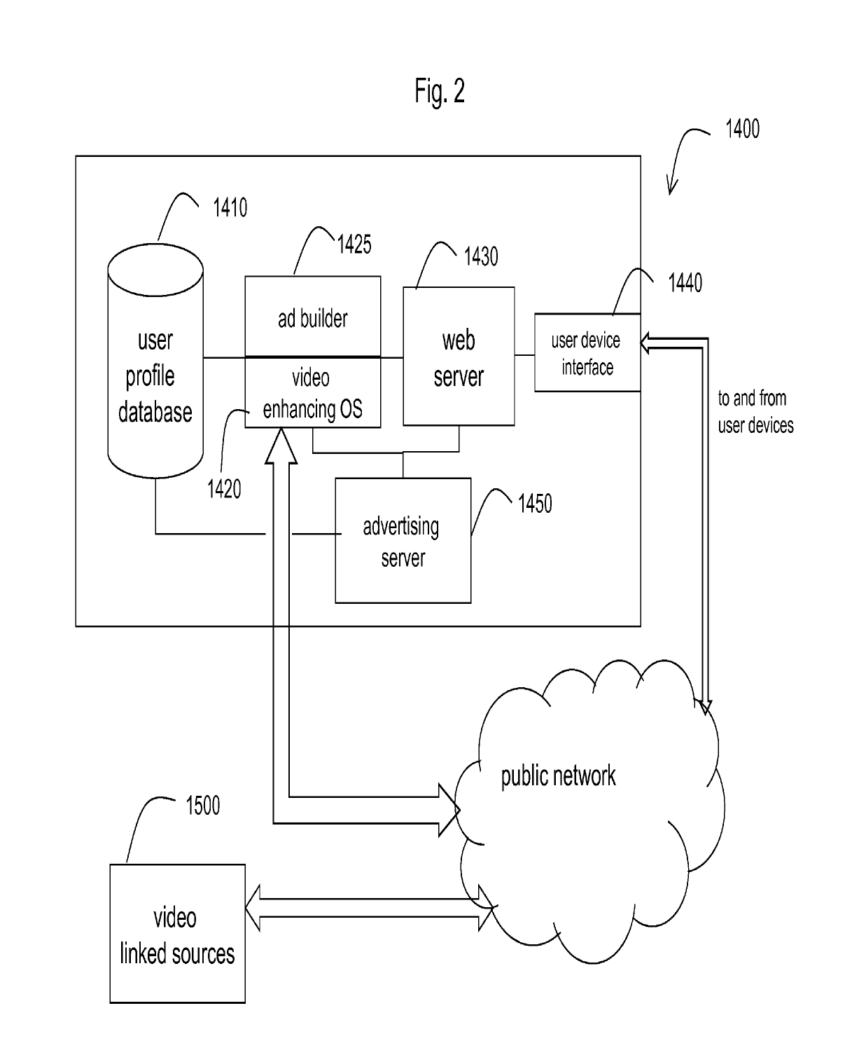

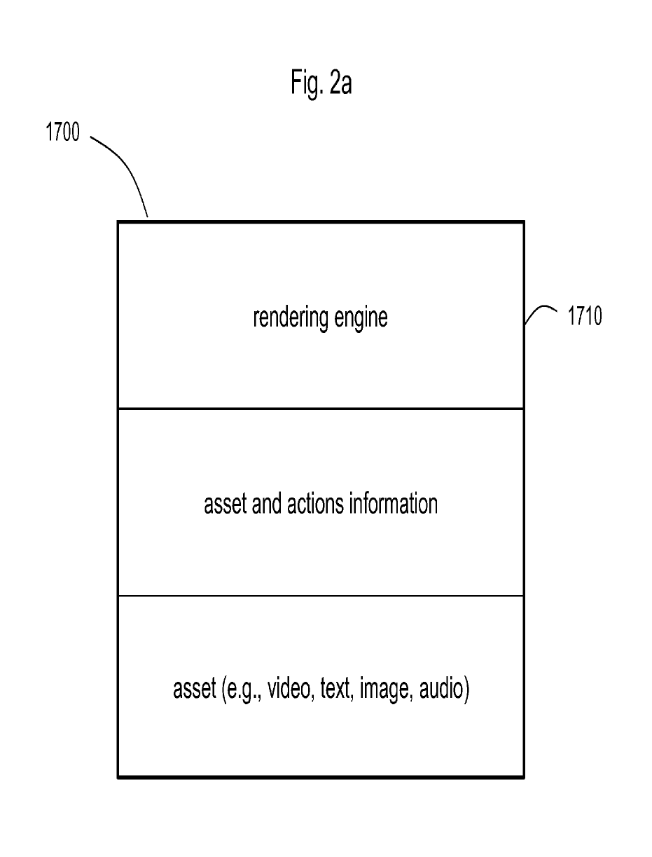

FIG. 2 shows an exemplary embodiment of the web-based platform for enhancing videos 1400. Generally, the platform 1400 includes a webserver 1430 configured to provide web services to web users. The terms user, web user, visitor and consumer are used interchangeably herein. The web server 1430 supports all web browsers, e.g., Internet Explorer, Chrome, Firefox, Safari, and so on. As such, the platform 1400 allows the user to grab video from most popular video sharing sites. The platform 1400 also includes a video enhancing operating system (OS) 1420 designed to provide video enhancement functions.

The video enhancing OS 1420 communicates with the linked sources or servers 1500 via the public network. The linked sources or servers 1500 provide video and/or data used to create and/or enhance a video. Alternatively, the video enhancing OS 1420 also communicates with private or local linked sources or servers 1500 via a private network. Generally, a user visits the platform 1400 via the web server 1430. The video enhancing OS 1420 then provides the user interfaces that allow the user to retrieve, load, and enhance a video. The video may be from any publicly linked source 1500, e.g., YouTube, or a private source. The video may be in any format known in video technologies, and created by any software or operating system. The video may also already have certain enhancements, such as pop-up text boxes. After the user loads the video from a linked source 1500, the user may use data from the same or other linked sources 1500 to enhance the video.

The video enhancing OS 1420, according to an embodiment, builds, or is used to build, dynamic data files 1700, shown in FIG. 2a, that can be distributed throughout the web (Internet). The video enhancing OS 1420 includes an ad builder 1425 that a user can use to enhance videos with new assets (e.g., video, text, image, audio, and so on) and actions (e.g., time based events, and so on). For example, the user may add a Twitter account, a map, and so on, at a selected time and location in the video. The resulting enhanced videos are files 1700, or part of files 1700 that can be stored at and distributed via ad servers 1600, including an ad server 1450 of the platform 1400, or other servers. The files 1700 may include code, and URL information that directs a browser where to load resources from. The code may include, for example, HTML5 code, Java scripts, and the like. The files 1700, with their assets and timed based events can be rendered on a browser and played on a user device (e.g., desktop, laptop, mobile, etc.). As a result, videos enhanced with the platform 1400 are dynamic, actionable, and full of links sourced directly from the web. The enhanced videos may behave like the web itself, dynamic, actionable and full of links.

The ad server 1450 and other ad servers 1600 load the data files 1700 that the ad builder 1425 generates. Each of these data files 1700 includes assets, actions, and a rendering engine 1710. The rendering engine 1710 is a time based action renderer. It directs the browser how to perform the time based execution of event sequences. The event sequences are enhancements that will be described herein. The rendering engine 1710 in turns loads timing and asset information. The asset information may include, for example, URL information for loading external media from external systems (e.g., Google maps, or images from an Internet connected storage system such as the Amazon Simple Storage Service, and the like). The assets may also include video, text, image, audio, third party application program interface (API), and so on. The rendering engine 1710 then combines all of the assets and time based events and plays them for the desktop or mobile browser client in the intended sequence.

The video enhancing OS 1420 keeps profiles of users and data in a user profile database 1410. Users of the platform 1400 may need to register with the platform 1400 before using the platform 1400. Alternatively, a tier of users may use the video enhance service without registration. These users can only access a limited number of services or functions and/or for a limited period of time. The registration may be free of charge, or the users may have to pay a subscription fee. The subscription fee may have one more tiers, each tier offering a different level of services. As such, the data stored in the user profiles include user personal information, payment information, user's device information, user's interests, favorite linked sources, and so on. For paid users, the user profile database 1410 also stores the saved videos of the user. Other data may include metrics and analytics data from the video enhancement sessions performed by the user. These data include, e.g., timestamp of session, session duration, any linked sources, and so on. Based on a predetermined arrangement with the user or a third party, the video enhancing OS 1420 may also send the metrics and analytics data to the user or the third party. As mentioned above, the platform 1400 may be distributed on one or more physical servers. The user profile database 1410 may be integrated with the platform 1400, or communicatively coupled to the platform 1400. The user profile database 1410 may be a single database or a distributed database, or resides in multiple databases.

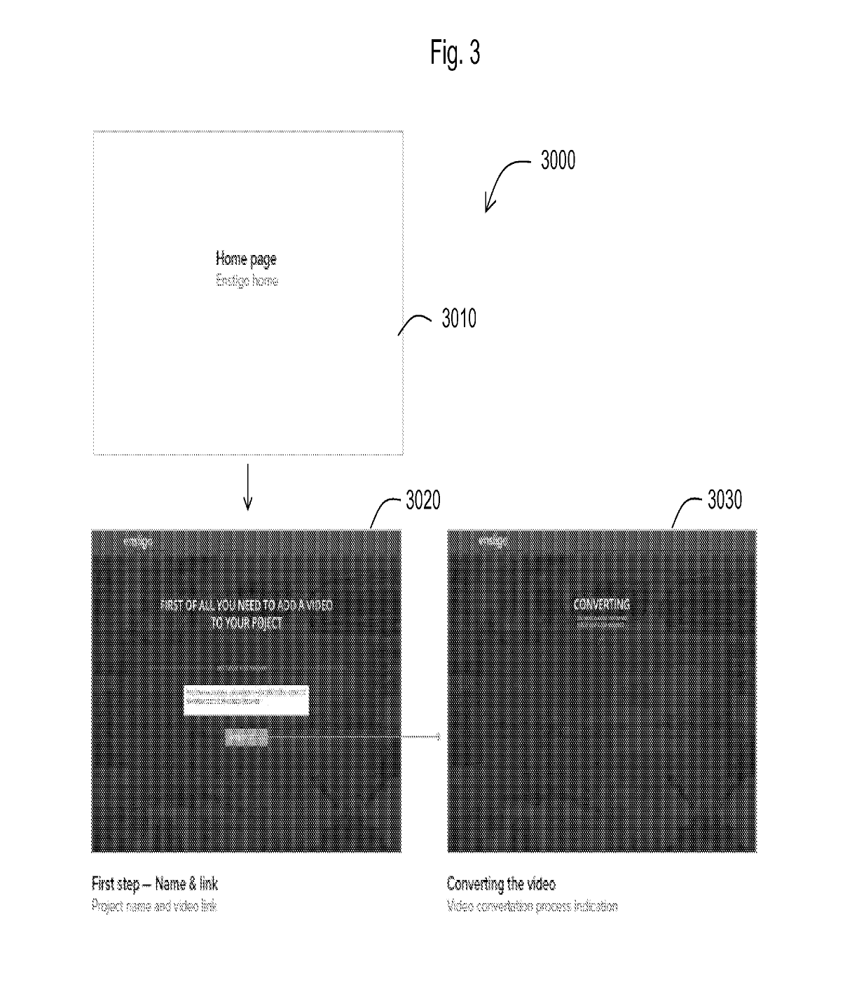

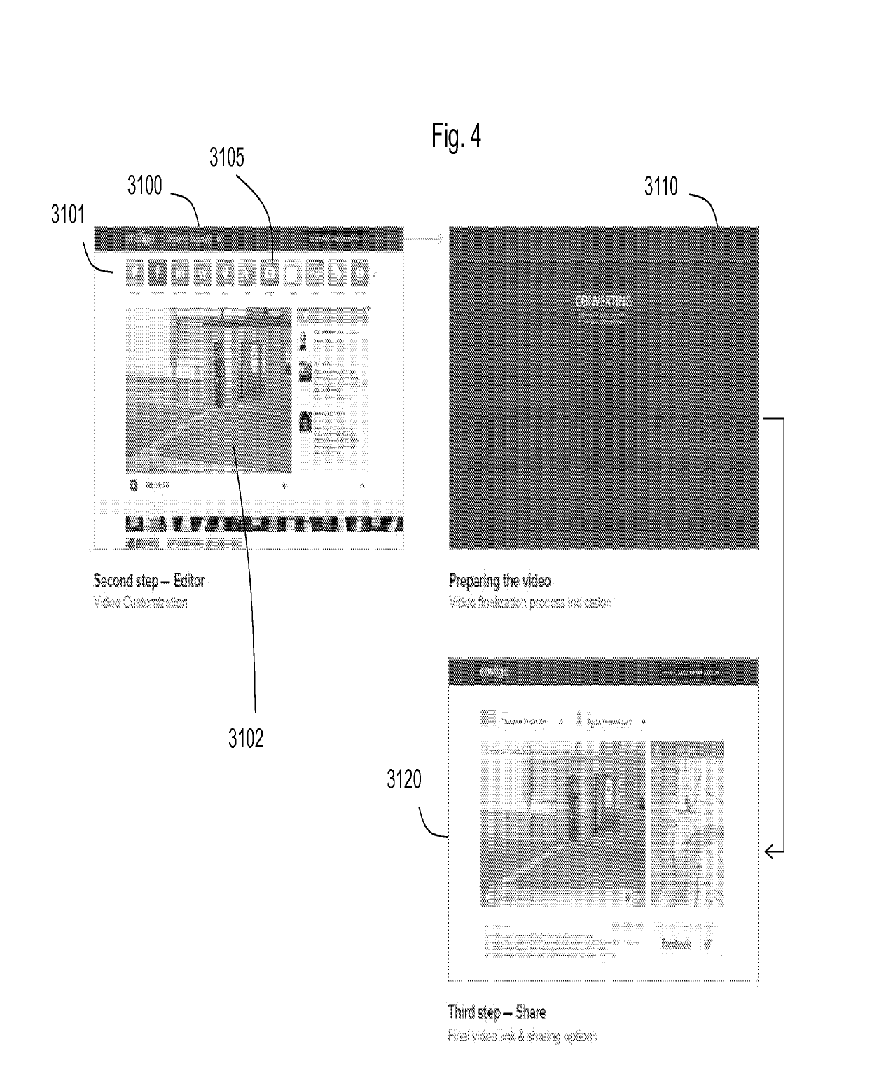

FIGS. 3 and 4 show an abridged example of the user interface 3000 provided by the video enhancing OS 1420. The user interface 3000 generally starts with the home page 3010. After the user enters the platform 1400 via the home page 3010, which may require secure login (not shown), the video enhancing OS 1420 displays the user interface 3020. If the user wants to create a new project, the user may enter a project name, which may be the name of a video (e.g., from YouTube), or the file name of the file that will be uploaded and a URL address from which the video enhancing OS 1420 can retrieve the video. Alternatively, the user may also enter a local source for the video. While the video enhancing OS 1420 retrieves and converts the video (e.g., converting into mobile device compatible industry formats, such as mp4 formatted to HTML5 video), it displays screen 3030.

User interface 3100 shows an exemplary video enhancement or customization process provided by the ad builder 1425. The ad builder 1425 provides a plurality of user interfaces to the user for editing and building a sequence of actions and assets in a video. The user can drag and drop applications (or apps) from an app bank 3101 into a builder stage 3102. Once apps are dropped into the builder stage 3102, the user can edit their attributes. For example, to create an ad unit, the user may drag and drop an image app 3105 from the app bank 3101 into the builder stage 3102, edit the dropped image app (not shown) to show an image from a URL or from the user's device. Once the user has completed the ad unit, the ad builder 1425 generates a self-contained file 1700 (while displaying screen 3110) that can be uploaded to the ad server 1450 or a third party ad server 1600, embedded via customized embed code in a blog, shared via email and social networks, and so on, as shown in screen 3120. In this embodiment, the user does not have to download and/or install any software on his computing device 1200/1300 to view the enhanced video, e.g., 3120.

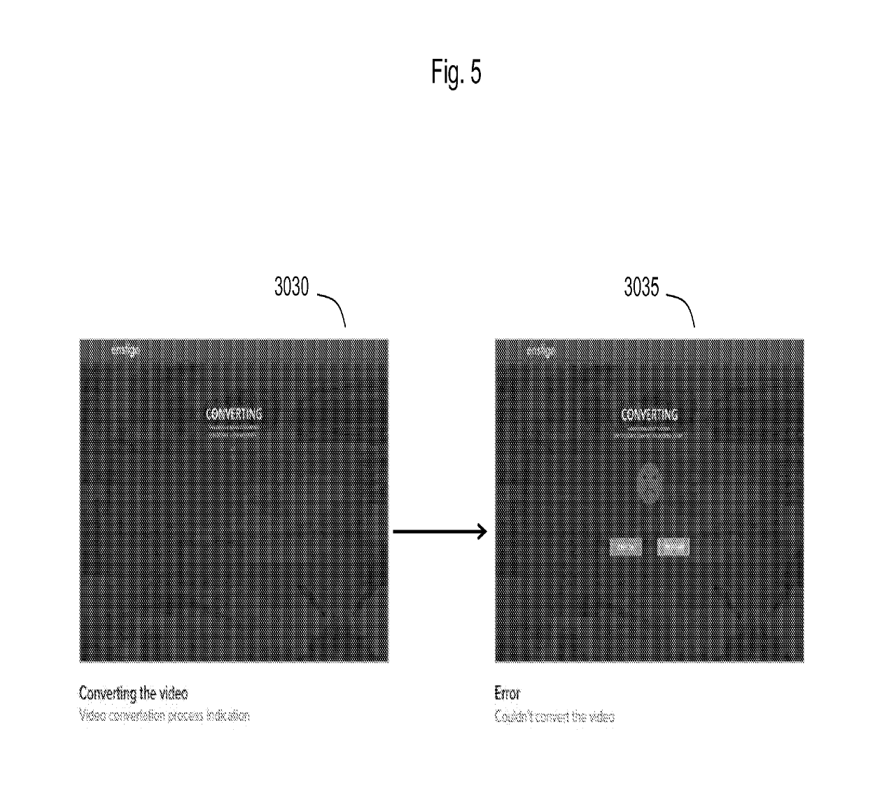

FIG. 5 shows an exemplary screen 3035 that the video enhancing OS 1420 displays if the conversion process of screen 3030 (FIG. 3) fails. At this point, the video enhancing OS 1420 returns to screen 3020 (FIG. 3) where the user may enter another video URL or local source.

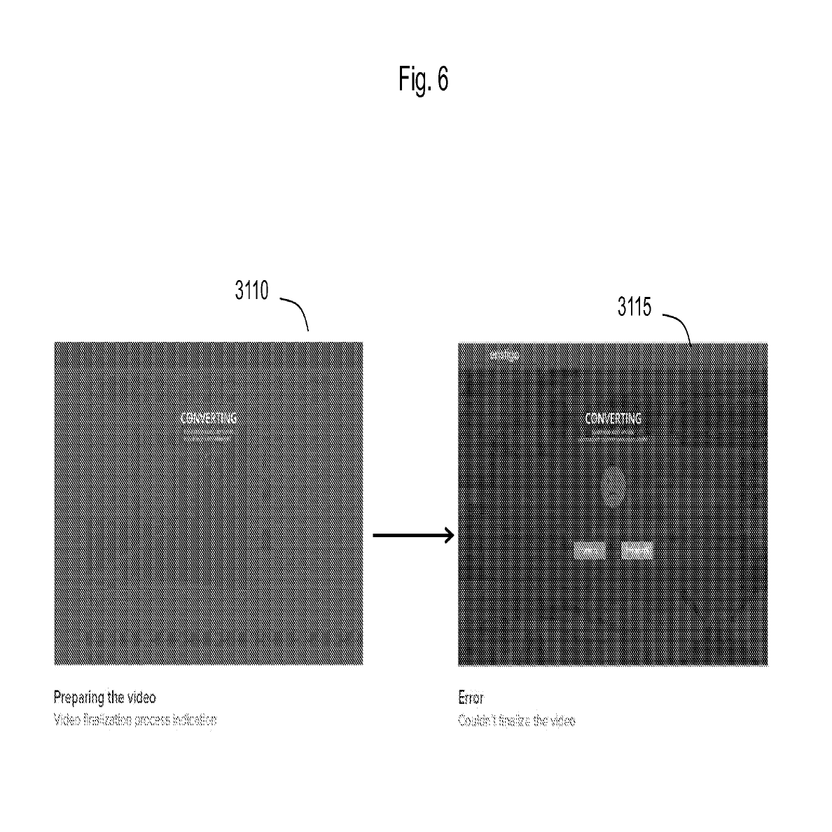

FIG. 6 shows an exemplary screen 3115 that the video enhancing OS 1420 displays if the conversion process of screen 3110 (FIG. 4) fails. At this point, the video enhancing OS 1420 returns the user to the customization process to correct the error causing the finalization process to fail.

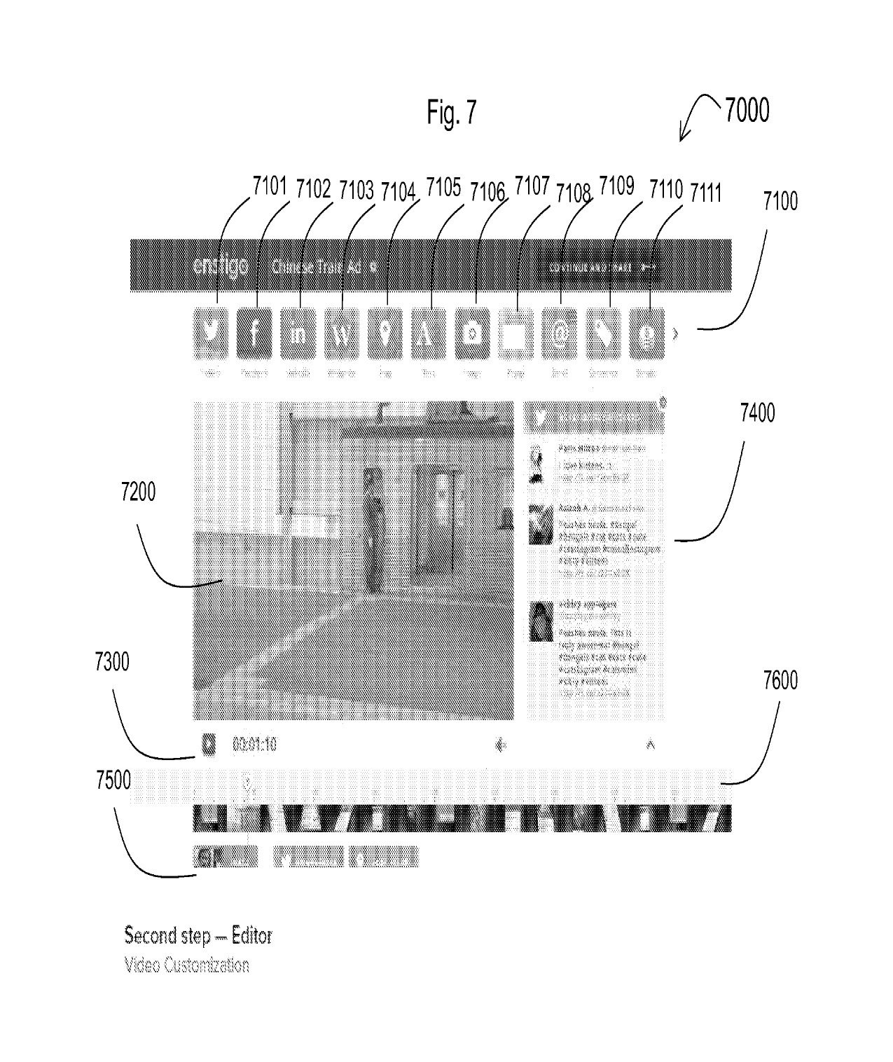

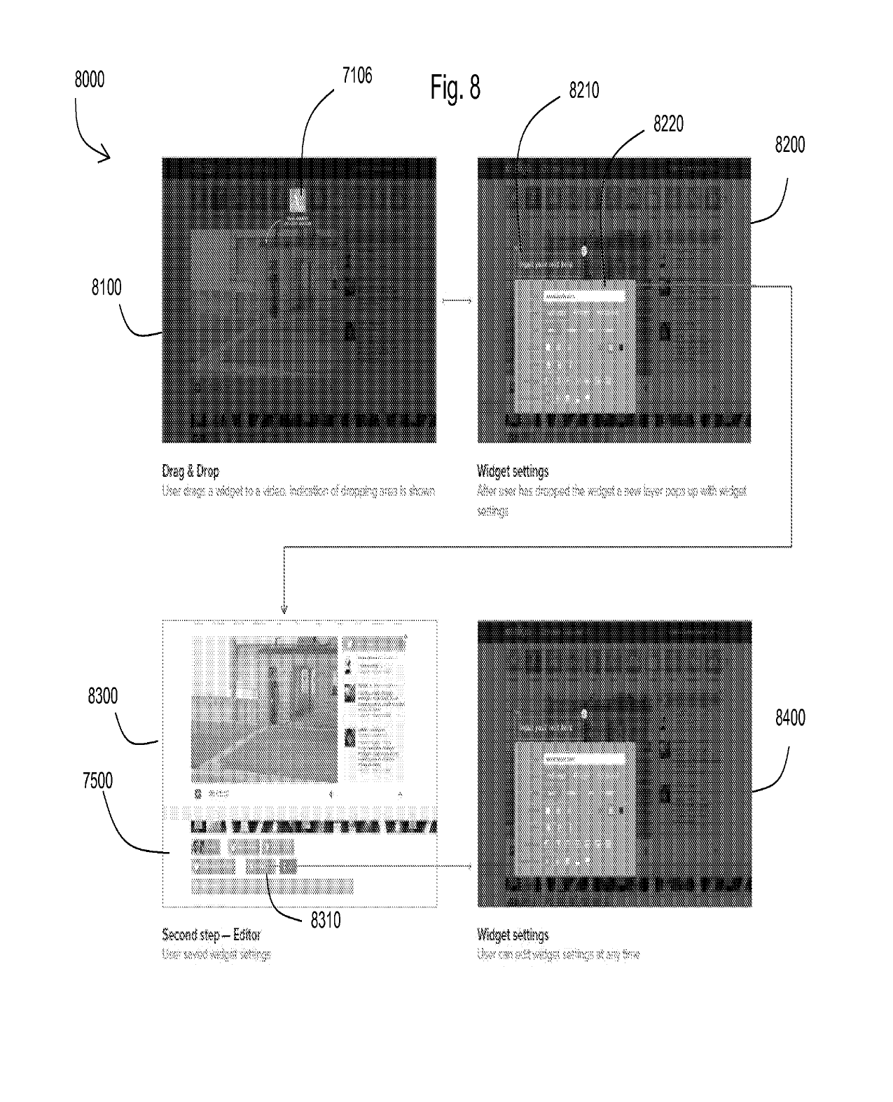

FIG. 7 shows an exemplary user interface 7000 of the video customization process. The user interface 7000 shows the video being customized in the builder stage 7200. The app bank 7100 is a modular system that encapsulates functionality of a third party service. For example, a map may be loaded from external system such as Google maps. As such, the app bank 7100 displays a plurality of apps 7101 to 7111 that the user may include in the video including, e.g., Twitter 7101, Facebook 7102, LinkedIn 7103, Wikipedia 7104, a Map software 7105, Text Box 7106, Image 7107, Popup 7108, an Email system 7109, an e-Commerce link 7110, an Internet link for donation 7111, and so on. As will be described herein, the user selects one or more of these apps, e.g., a map, a text box, an image, and so on, to insert into the video. A time counter 7300, e.g., 00:01:10, shows the time progress of the video. The Active Sidebar 7400 generally shows the linked active app from an external source. The user then inputs metadata in the Active Sidebar 7400. The metadata is used to correctly generate a layer that pulls in relevant data. The linked active app will communicate via application programming interface (API) to a third party service such as Facebook, Linkedin, Twitter, and so on, to pull in the relevant data. For example, if a user drops in the Twitter app 7101 in the ad builder 1425, the user will be asked what username they would like to pull data from. The user types in the username, e.g., @CNN, the platform 1400 uses the username as metadata and generate a layer that will pull in the most recent tweets from the CNN Twitter account. Section 7600 shows screenshots of the video on a time line. Section 7500 shows one or more media and events (enhancements) that the user has added to the video. The media and events are a visual representation of what events will be fired at what time (see FIG. 8).

FIG. 8 shows an exemplary user interface 8000 wherein the user may insert an enhancement into the video. This user interface 8000 will be similar for all types of enhancements shown herein. While viewing a video, the user pauses at a video frame where the user wants to insert an enhancement. For example, at screen 8100, the user desires to add a text box (an enhancement) to the video at time counter 00:01:10. The user drags the desired app, e.g., Text Box 7106, from the app bank 7100 and drops the app in the location in the video frame (in the builder stage 7200) where the user wants the enhancement (e.g., the text box) to display during playback of the video. As a result, the ad builder 1425 pops up a new layer with window 8210 where the user can enter the desired enhancement (e.g., a text). The ad builder 1425 provides window 8220 for formatting and/or changing the attributes of the enhancement. The user may also insert one or more URL addresses using window 8220. When the user completes inserting the enhancement, a corresponding enhancement (media and events) index 8310 is shown in section 7500. By reviewing section 7500, the user will see all enhancements made to the video. The user may select one or more media or events, e.g., text media 8310, to edit the corresponding enhancement, as shown in screen 8400.

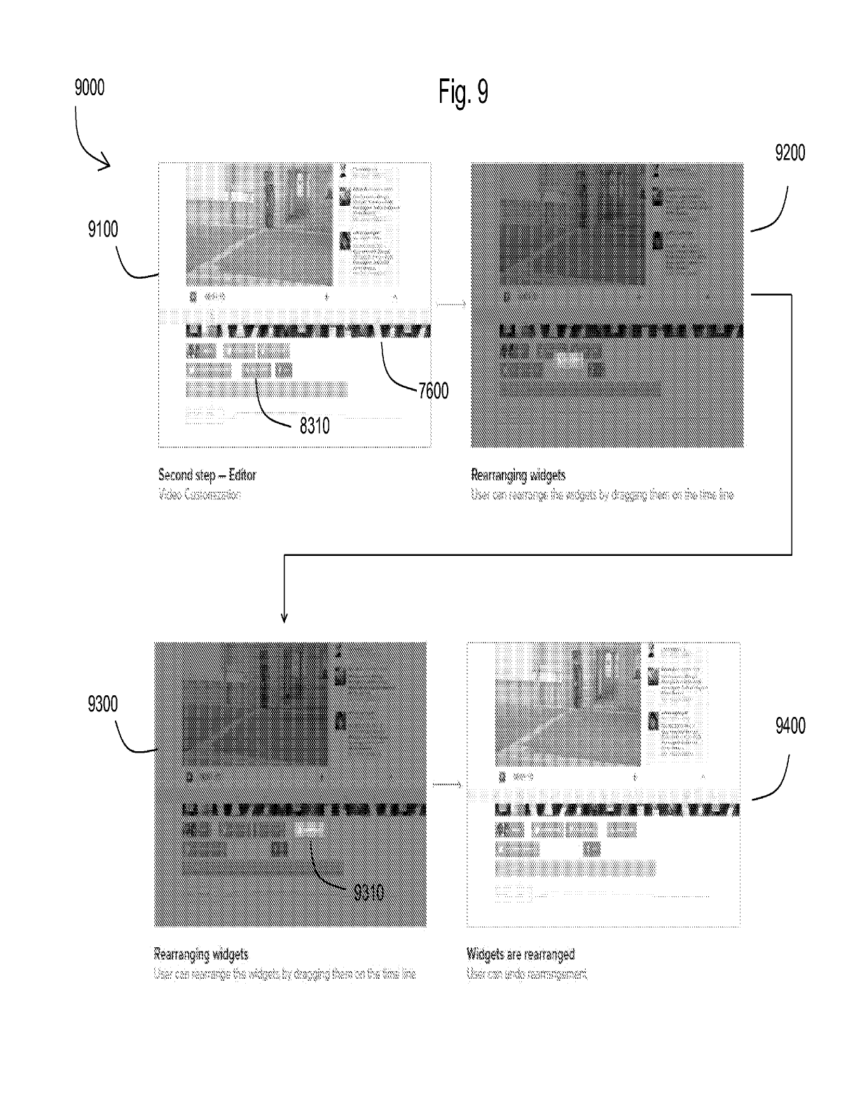

FIG. 9 shows an exemplary user interface 9000 wherein the user can re-arrange one or more enhancements (media and events) in the video. At screen 9100, the user desires to move the exemplary text box 8310 to a different time in the video. The user selects the text box media 8310, drags the text box media 8310 to a desired time location 9310 in the time line 7600, as shown in screens 9200-9400. With all enhancements, the user may select to undo one or more edits made.

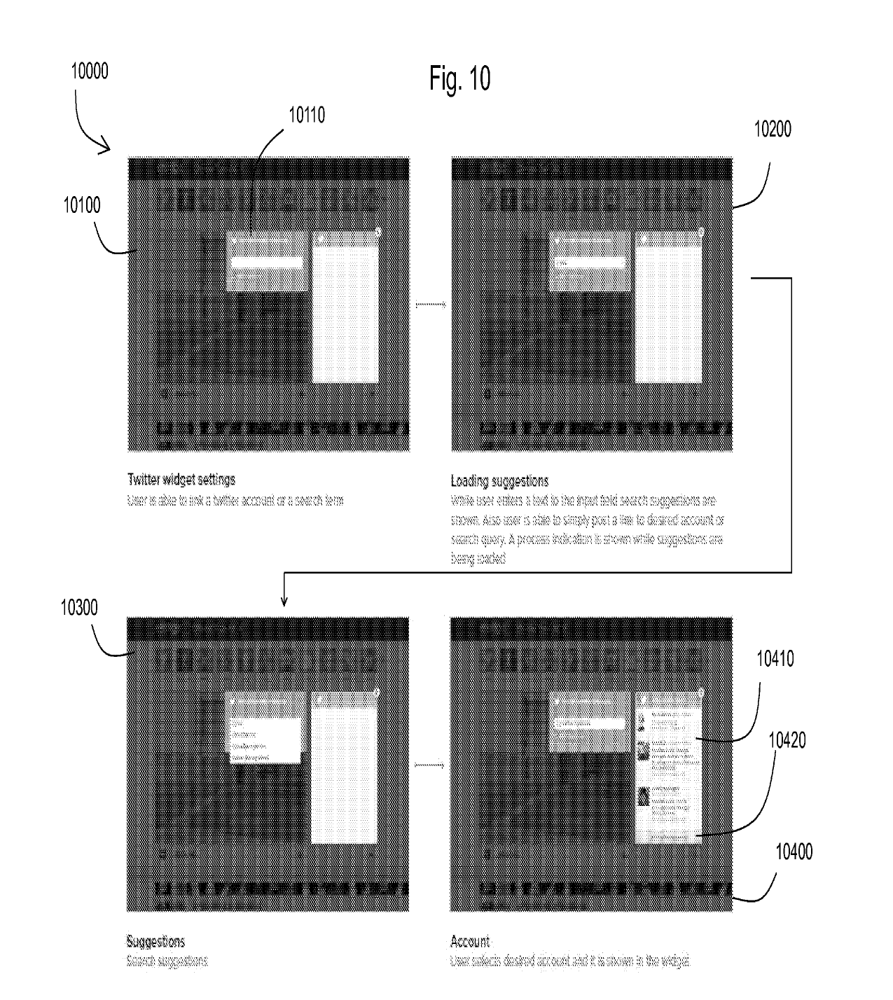

FIGS. 10-20 show exemplary user interfaces for some exemplary types of enhancements that the platform 1400 supports.

FIG. 10 shows an exemplary user interface 10000 wherein the user can insert one or more social communication enhancements, e.g., Twitter, Instagram, Pinterest, and so on, into the video. With the exemplary Twitter enhancement of user interface 10000, the user can link a Twitter account to a desired location in a video frame. The user first selects the Twitter app 7101 from the app bank 7100 and drops the app in the location in the video frame where the user wants the Twitter function to display and run during playback of the video. As a result, the ad builder 1425 pops up a new layer with window 10110 where the user can enter the desired Twitter account. The ad builder 1425 provides search suggestions while the user enters a text to an input field, e.g., the input field of window 10110, as shown in screen 10300. The ad builder 1425 also shows a process indication while the suggestions are being loaded, and an option to add a Twitter follow button 10420 in the Twitter window. The user either selects one of the suggested Twitter accounts, or enters a link. As a result, a Twitter communication window 10410 is displayed when the video is played back, and the viewer will receive live Twitter posts from the selected account. During playback, if the viewer pauses the video, the live receipt of Twitter posts continues until the viewer resumes the playback. If the viewer selects the Twitter follow button, a new Twitter window will pop up. At this time, the video pauses to allow the viewer to sign up to follow the Twitter member.

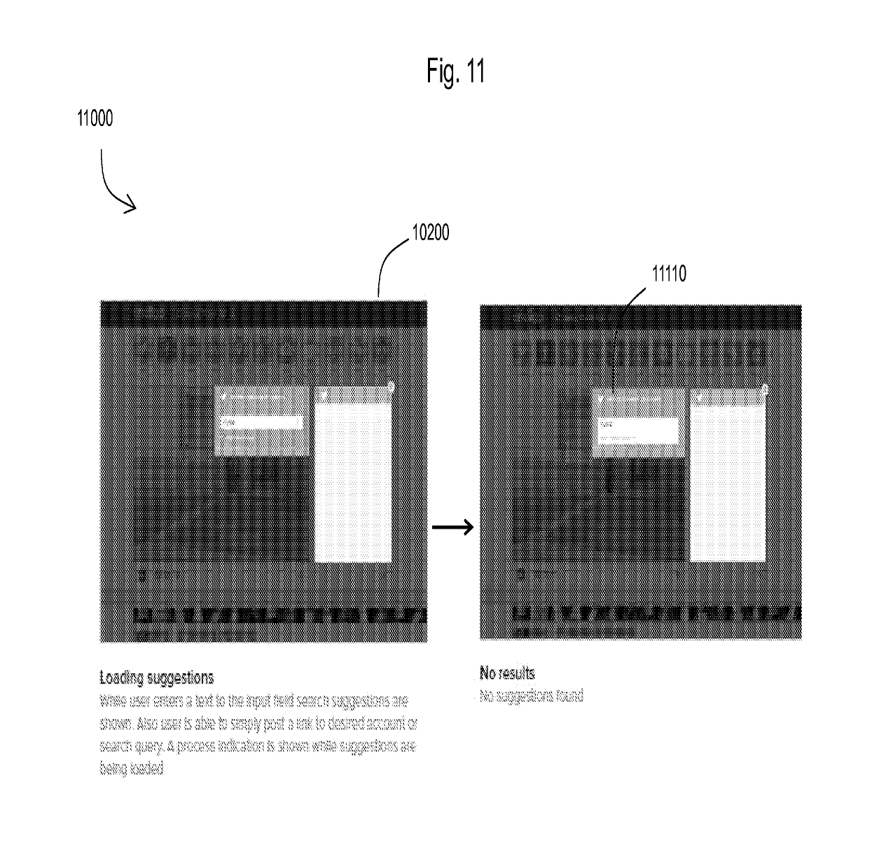

FIG. 11 shows an exemplary user interface 11000 wherein the ad builder 1425 displays window 11110 to indicate that the ad builder 1425 did not find any suggestion for the Twitter account being entered.

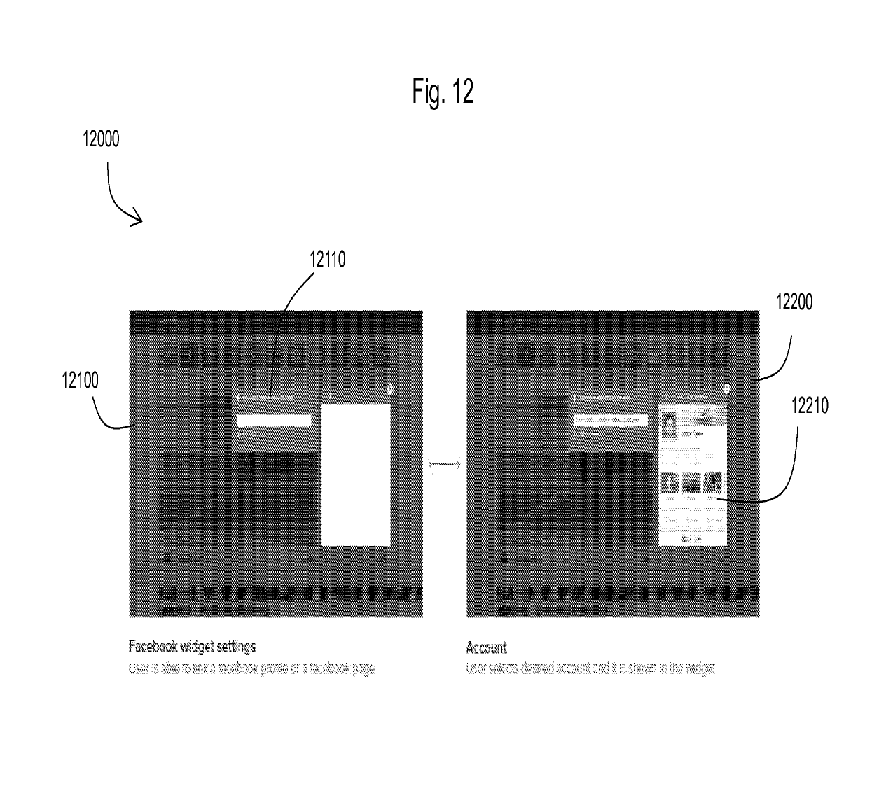

FIG. 12 shows an exemplary user interface 12000 wherein the user can insert one or more social networks enhancements, e.g., Facebook, Google+, and so son, into the video. With the exemplary Facebook enhancement of user interface 12000, the user can link a Facebook account to a desired location in a video frame. The user first selects the Facebook app 7102 from the app bank 7100 and drops the app in the location in the video frame where the user wants the Facebook function to display and run during playback of the video. The ad builder 1425 pops up a new layer with window 12110 where the user can enter the desired Facebook account, e.g., a link to a Facebook profile or a Facebook page. As a result, ad builder 1425 displays a Facebook communication window 12210. When the video is played back, the viewer will receive access to the selected Facebook account. During playback, if the viewer pauses the video, the live access to the Facebook account continues until the viewer resumes the playback, or logs out of the Facebook account.

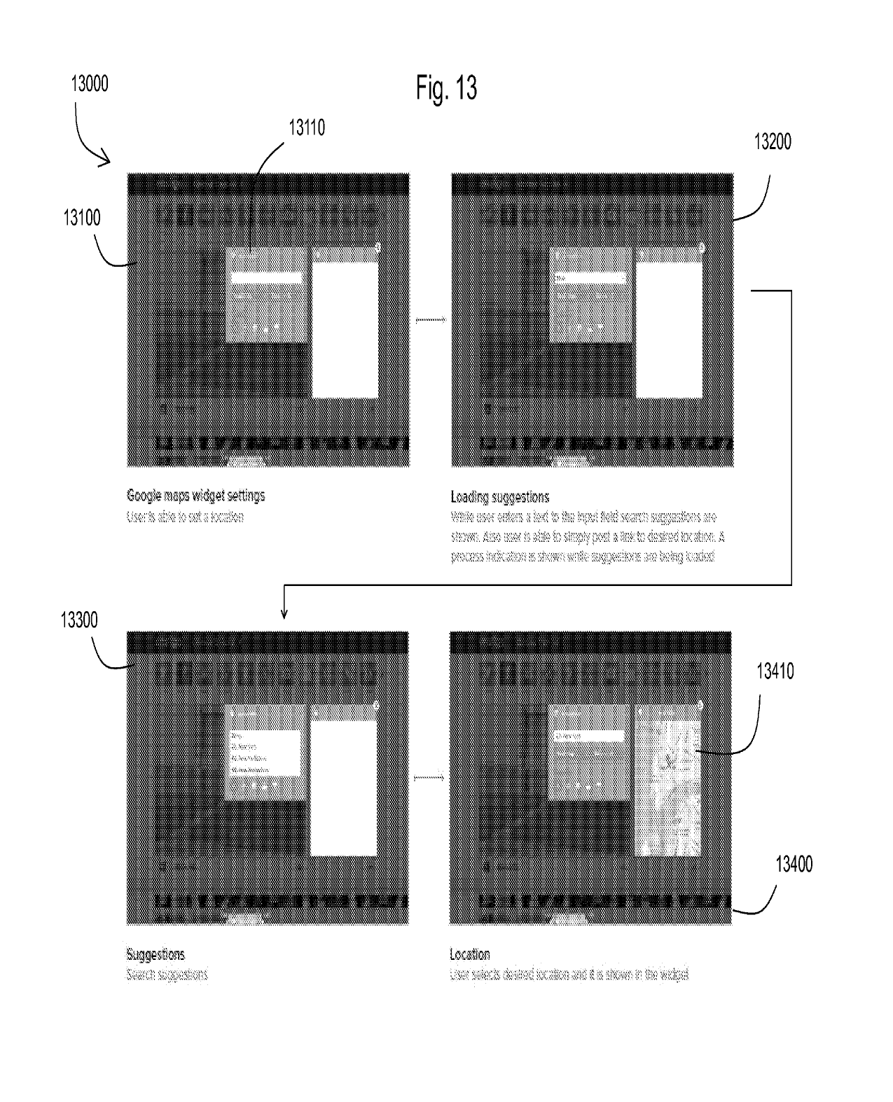

FIG. 13 shows an exemplary user interface 13000 wherein the user can insert one or more map enhancements, e.g., Google maps, Yahoo! Maps, and so on, into the video. With the exemplary Google maps enhancement of user interface 13000, the user can link a Google map to a desired location in a video frame. The user first selects the map app 7105 from the app bank 7100 and drops the app in the location in the video frame where the user wants the map function to display and run during playback of the video. As a result, the ad builder 1425 pops up a new layer with window 13110 where the user can enter the desired map information, e.g., an address. The ad builder 1425 provides search suggestions while the user enters a text to an input field, e.g., the input field of window 13110, as shown in screen 13300. The ad builder 1425 also shows a process indication while the suggestions are being loaded. As a result, a map window 13410 is displayed when the video is played back, and the viewer will receive access to the selected map, including all interactive functions.

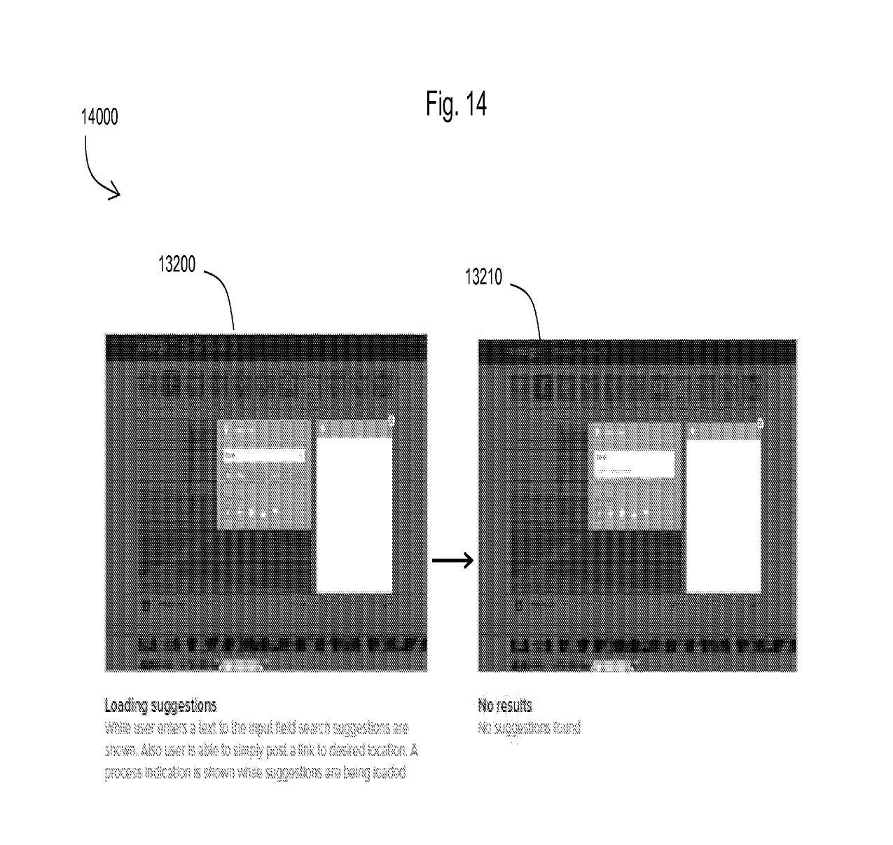

FIG. 14 shows an exemplary user interface 14000 wherein the ad builder 1425 displays window 13210 to indicate that the ad builder 1425 did not find any suggestion for the map information, e.g., an address, entered by the user.

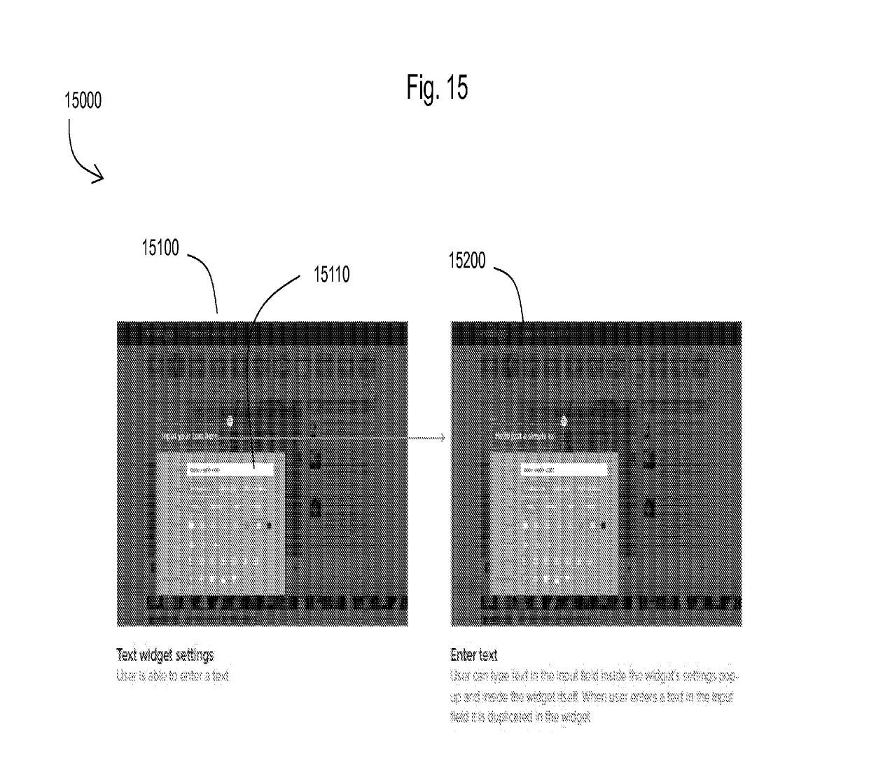

FIG. 15 shows an exemplary user interface 15000 wherein the user can insert one or more text enhancements into the video. At screen 15100, the user drags the Text Box app 7106 from the app bank 7100 and drops the app in the location in the video frame where the user wants the text box to display during playback of the video. As a result, the ad builder 1425 pops up a new layer with window 15110 where the user can enter the desired text. Alternatively, the user may import a text file. Window 15200 provides formatting and/or setting information for formatting the text in the enhancement. The user may also insert one or more URL addresses. As a result, a text box is displayed when the video is played back.

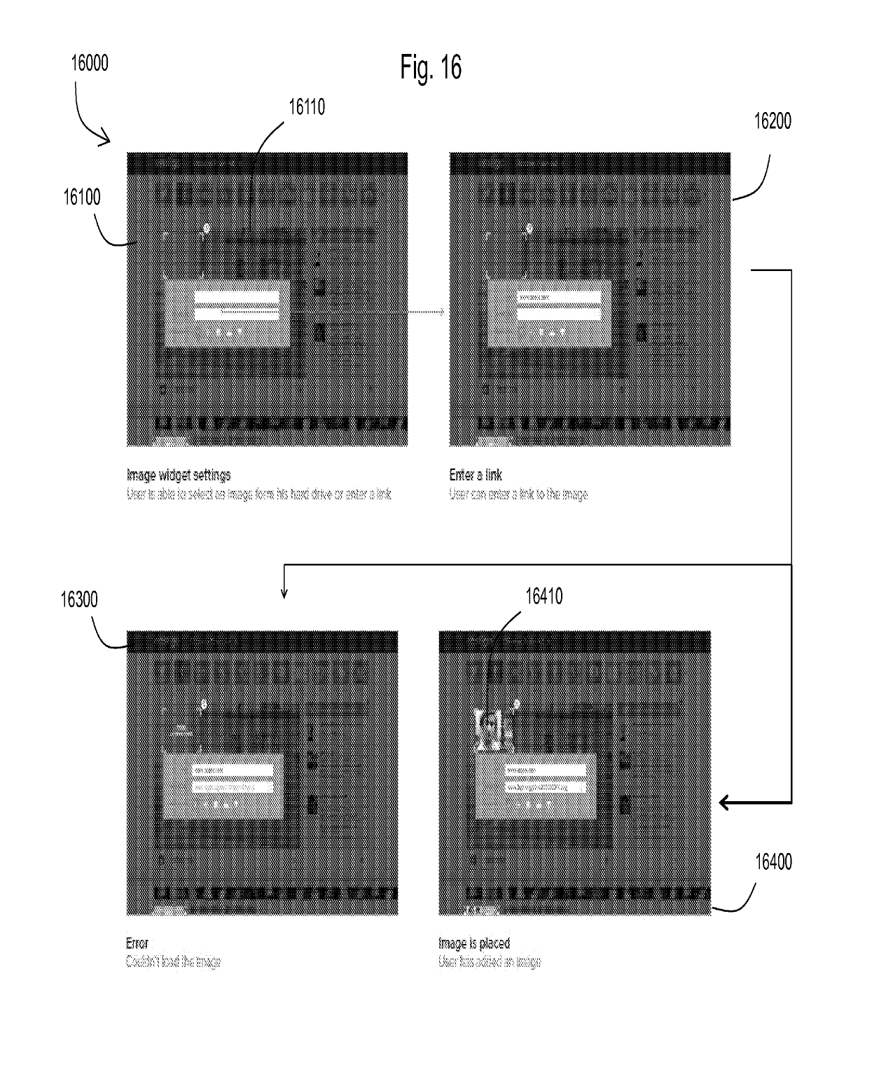

FIG. 16 shows an exemplary user interface 16000 wherein the user can insert one or more image enhancements into the video. At screen 16100, the user drags the Image app 7107 from the app bank 7100 and drops the app in the location in the video frame where the user wants the image enhancement to display during playback of the video. As a result, the ad builder 1425 pops up a new layer with window 16110 where the user can insert the desired image. The image can be inserted from the storage system of the user computer, e.g., a hard drive, a USB device, a networked system, and so on. The user may also insert one or more URL addresses for retrieving the image. The ad builder 1425 displays window 16300 to indicate that the ad builder 1425 did not find the image as indicated by the user, or could not load the image. The ad builder 1425 displays window 16400 when it successfully finds the image. As a result, the image 16410 is displayed when the video is played back.

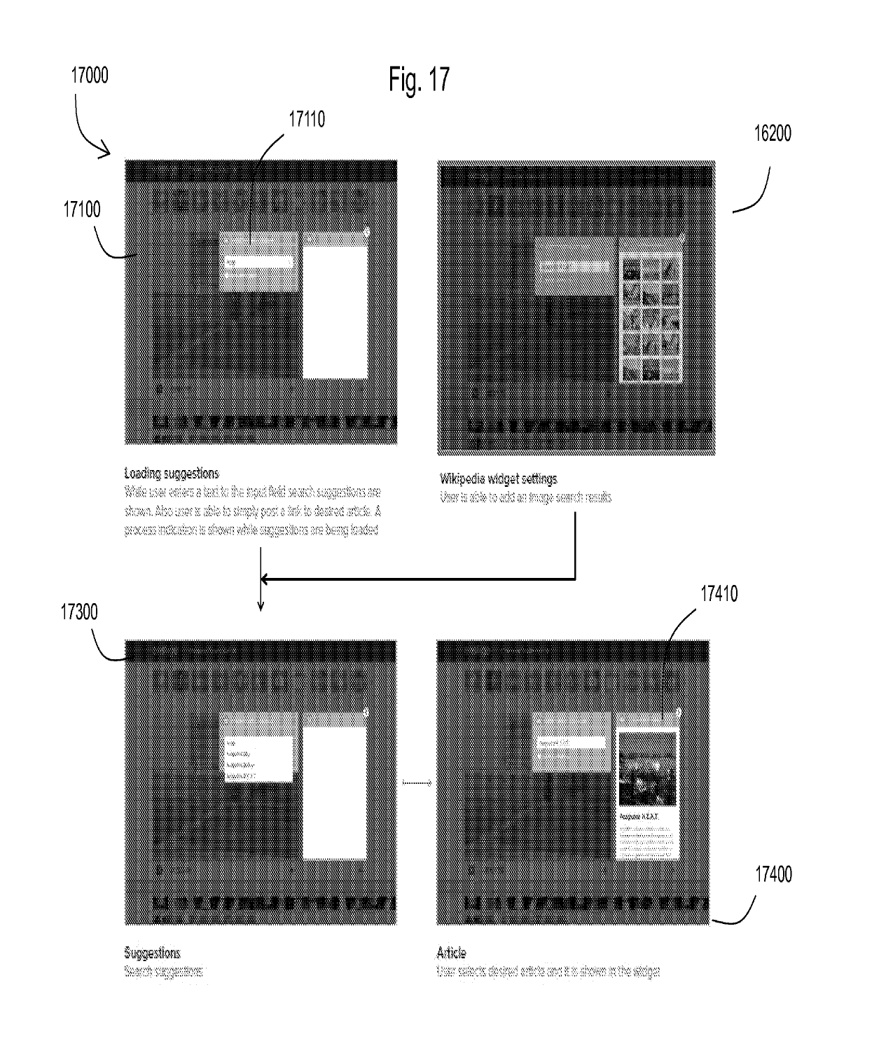

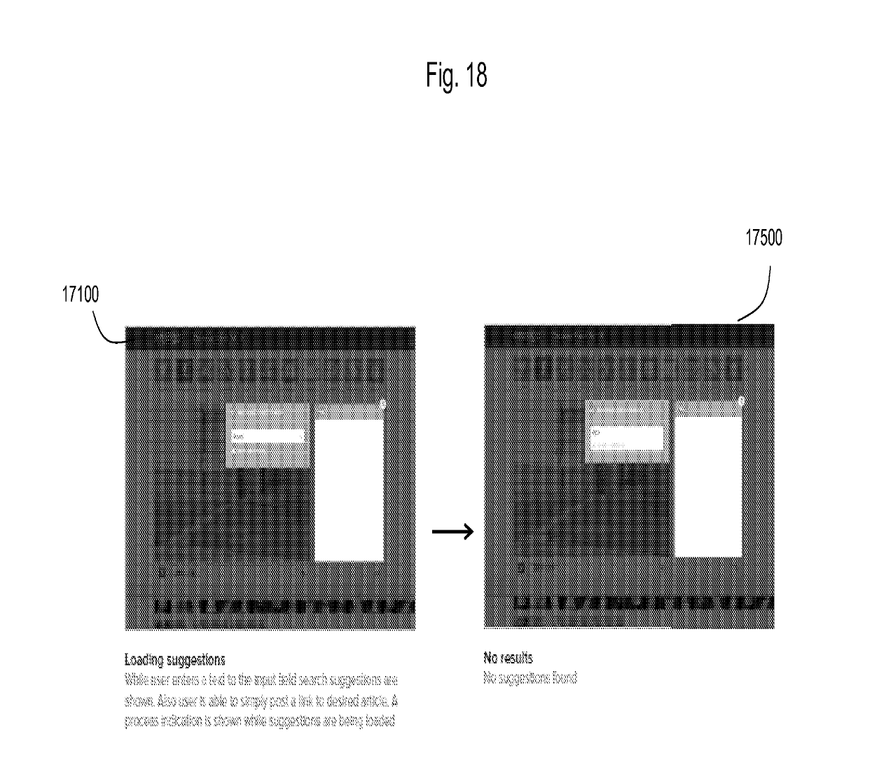

FIGS. 17-18 show an exemplary user interface 17000 wherein the user can insert one or more Wiki enhancements, e.g., Wikipedia, into the video. At screen 17100, the user drags the Wiki app 7104 from section 7100 and drops the app in the location in the video frame where the user wants the Wiki enhancement to display during playback of the video. As a result, the video ad builder 1425 pops up a new layer with window 17110 where the user can insert the desired Wiki enhancement. The ad builder 1425 provides search suggestions while the user enters text string to an input field, e.g., the input field of window 17110. The suggestions may also include one or more images. The ad builder 1425 also shows a process indication while the suggestions are being loaded. The user either selects one of the suggested texts or images, or enters a separate text. The ad builder 1425 displays window 17400 when it successfully finds the Wiki information. As a result, the Wiki information 17410 is displayed when the video is played back. The ad builder 1425 displays window 17500 to indicate that the ad builder 1425 did not find any suggestion for the Wiki information entered by the user.

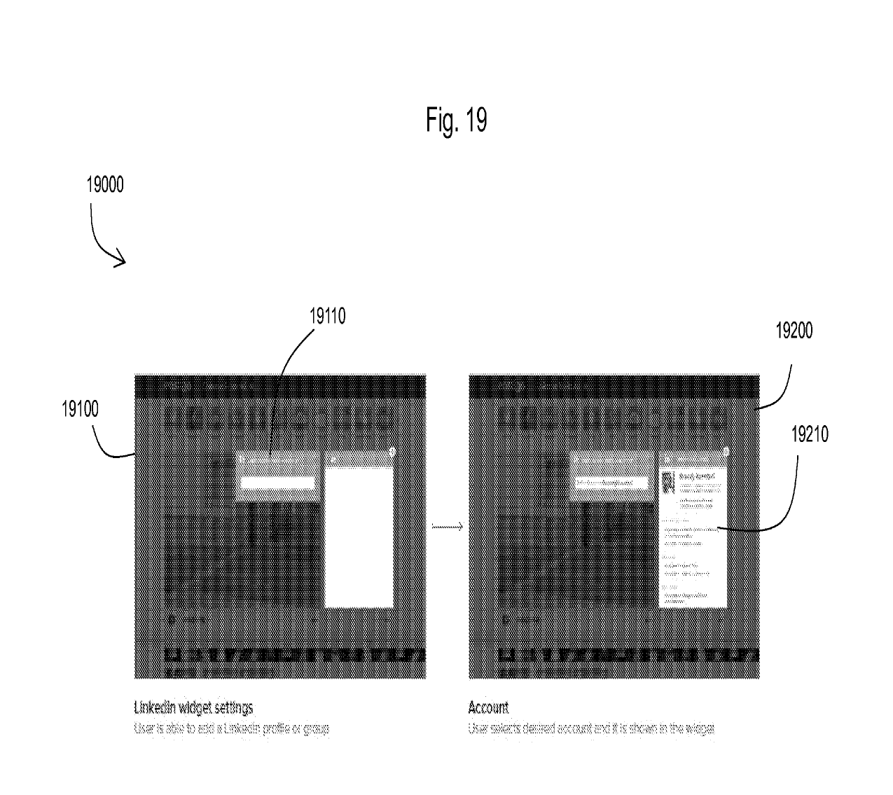

FIG. 19 shows an exemplary user interface 19000 wherein the user can insert one or more professional networking enhancements, e.g., LinkedIn, and so son, into the video. With the exemplary LinkedIn enhancement of user interface 17000, the user can link a LinkedIn account to a desired location in a video frame. The user first selects the LinkedIn app 7103 from the app bank 7100 and drops the app in the location in the video frame where the user wants the LinkedIn function to display and run during playback of the video. As a result, the ad builder 1425 pops up a new layer with window 19110 where the user can enter the desired LinkedIn account, e.g., a link to a LinkedIn profile or a LinkedIn group. As a result, the ad builder 1425 displays a LinkedIn communication window 19210. When the video is played back, the viewer will receive access to the selected LinkedIn account. During playback, if the viewer pauses the video, the live access to the LinkedIn account continues until the viewer resumes the playback, or logs out of the LinkedIn account.

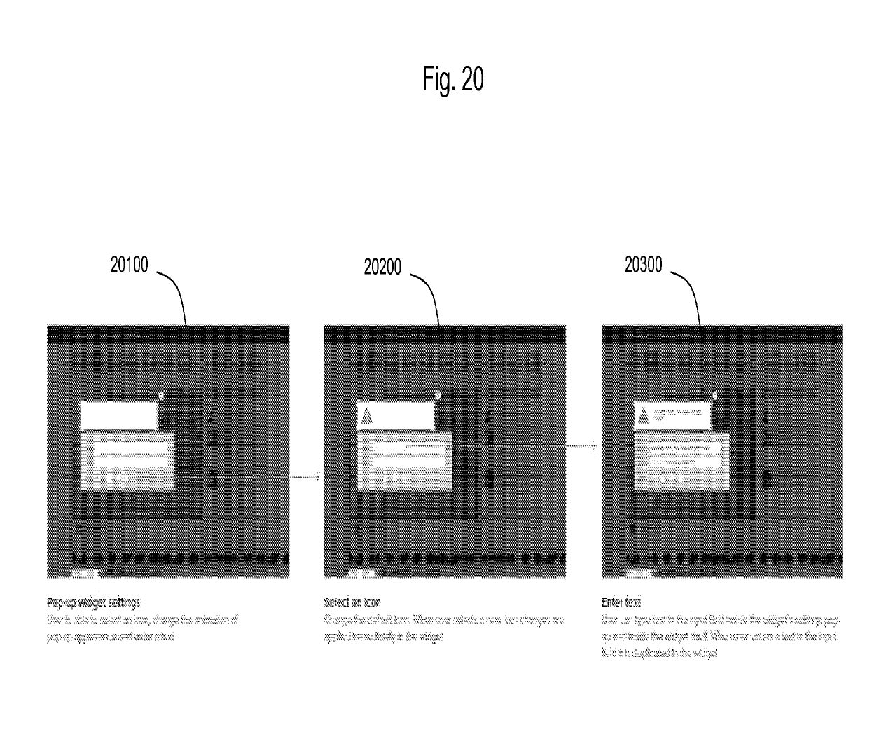

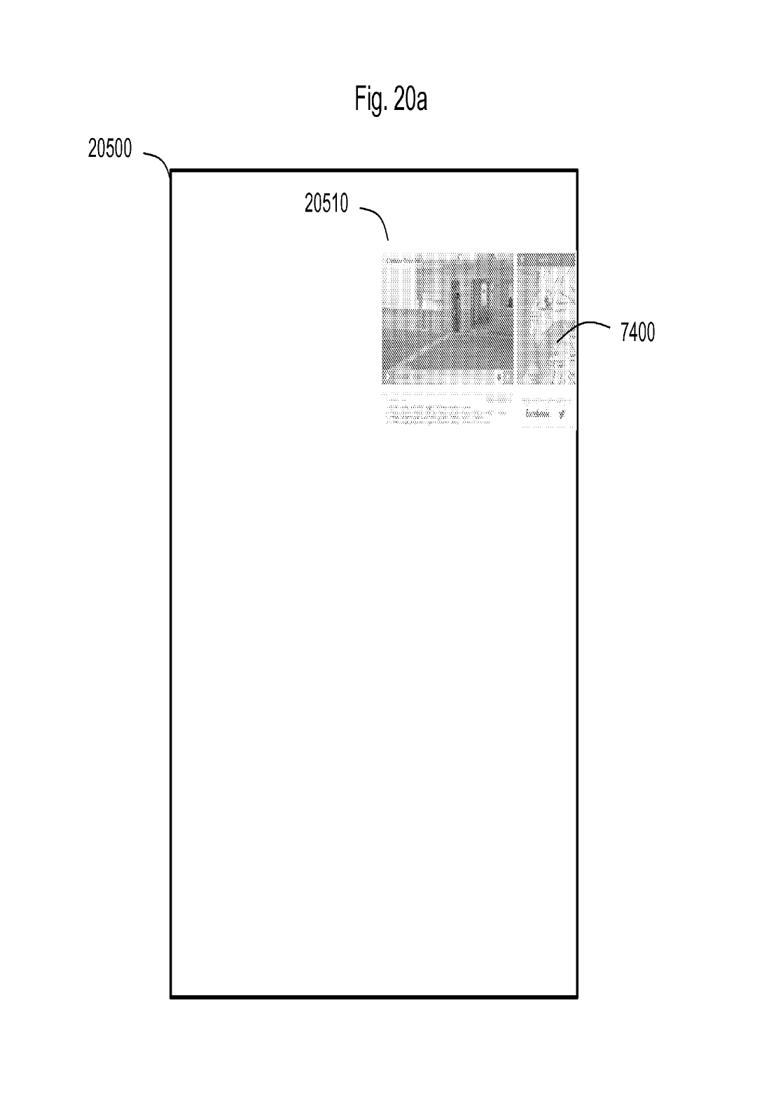

FIG. 20 shows an exemplary user interface 20000 wherein the user can select one or more apps 7101-7111, change the animation of the pop-up appearance and enter a text. With the exemplary pop-up modification of user interface 20000, the user first selects the Popup app 7108 from the app bank 7100 and drops the app in the current video frame. The user then selects an app for modification. As the user modifies and changes the default app, changes are applied immediately, including text being typed by the user.

FIG. 20a, according to an embodiment, shows an exemplary webpage 20500 wherein an ad unit 20510 is rendered. The ad unit 20510 includes the video enhanced by the platform 1400 and the Active Sidebar 7400.

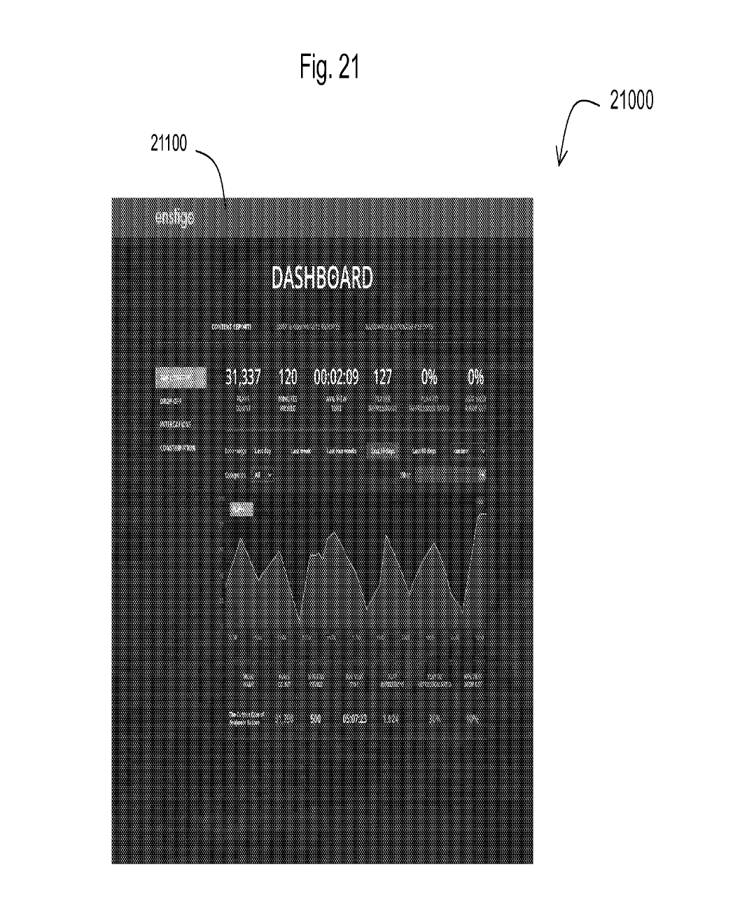

FIG. 21 shows an exemplary analytics report 21000 of the platform 1400. The analytic report 21000 is part of the video dashboard 21100, which displays data relating to the individual and aggregated videos in the user's account. Data such as video plays, minutes watched, average view time, player impressions, plays to impression ratio, average, view drop-off, and so on. These data points allow the user to see the performance of the individual video ads.

### Preferred Processes

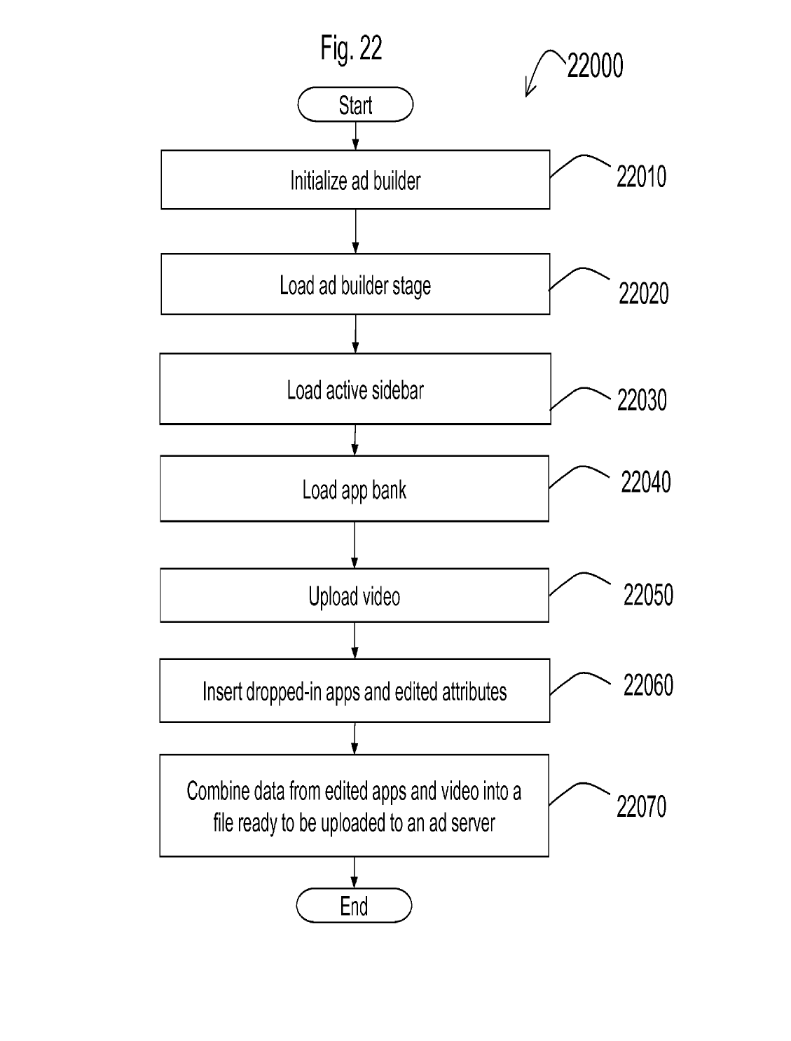

FIG. 22 shows a description of the operation 22000 of the platform 1400. The video enhancing OS 1420 first initializes the ad builder 1425 (Action Block 22010). The ad builder then loads the builder stage 7200 (Action Block 22020), the Active Sidebar 7400 (Action Block 22030), and the app bank 7100 (Action Block 22040). After a user logs into the platform 1400 and provides the source for the video, e.g., a URL address or a local storage address, the ad builder 1425 uploads the video (Action Block 22050). As the user drops in apps from the app bank 7100 to the builder stage 7200, the ad builder 1425 inserts timing data and app data which become part of a data file 1700 (Action Block 22060). When the user finishes the enhancements (building the ad), the ad builder 1425 combines data from the edited apps and video into a file 1700 ready to be uploaded to an ad server 1450 or a third party ad server (Action Block 22070).

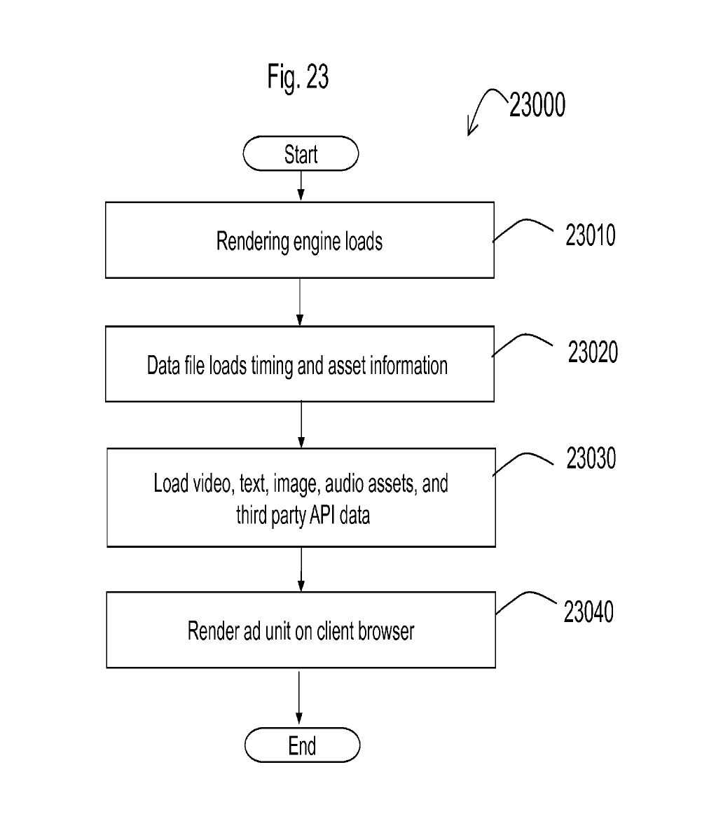

FIG. 23 shows a description of the operation 23000 of the rendering engine 1710 in the data file 1700 generated by the ad builder 1425. The data file 1700 is first stored at or uploaded to an ad server 1450 or a third party ad server. The rendering engine 1710 of the data file 1700 then loads, e.g., in a browser client, when a webpage is loaded with an ad unit built with the data file 1700 (Action Block 23010). The rendering engine 1710 then loads timing and asset information contained in the data file 1700 (Action Block 23020). Based on the asset information, the rendering engine 1710 loads video, text, image, audio assets, and/or third party API data (Action Block 23030). With these information, the rendering engine 1710 renders the ad unit on the client browser (Action Block 23040).

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions described herein is merely illustrative, and the invention may appropriately be performed using different or additional process actions, or a different combination or ordering of process actions. For example, this invention is particularly suited for enhancing video from communication devices over the Internet; however, the invention can be used for any video, text, image, or audio enhance service system in general. Additionally and obviously, features may be added or subtracted as desired. Accordingly, the invention is not to be restricted except in light of the attached claims and their equivalents.

What is claimed is:

1. A computer-based system for web-based video enhancing, comprising:
a video enhancing operating system, operatively coupled to a web server and a public network, having a database that stores profiles of a plurality of users, wherein the video enhancing operating system is configured to:
receive source information of a video;
retrieve the video;
convert the video to a predetermined format;
receive request to make an enhancement to the video;
enhance the video; and
combine the video into a self-contained file comprising a rendering engine and the enhancement.

2. A computer-based system for web-based video enhancing, comprising:
a video enhancing operating system, operatively coupled to a web server and a public network, having a database that stores profiles of a plurality of users, wherein the video enhancing operating system comprises an ad builder which is configured to:
load an ad builder stage interface;
load an active sidebar interface;
load an app bank interface;
upload a video;
receive one or more apps dropped in the builder stage interface from the app bank interface;
receive edits for one or more attributes of the one or more apps dropped in the builder stage interface; and
combine the one or more apps and the video into a file.

3. A data file comprising:
assets comprising at least on of video, text, image, and video;
actions;
information for the assets and actions; and
a rendering engine to render the assets and actions.
